(19) United States
(12) Patent Application Publication
(10) Pub. No.: US 2013/0071781 A1
(43) Pub. Date: Mar. 21, 2013

(54) ELECTROSTATIC CHARGE IMAGE DEVELOPING TONER, ELECTROSTATIC CHARGE IMAGE DEVELOPER, TONER CARTRIDGE, PROCESS CARTRIDGE, IMAGE FORMING APPARATUS, AND IMAGE FORMING METHOD

(71) Applicants: Yutaka SAITO, Kanagawa (JP); Sakon TAKAHASHI, Kanagawa (JP); Katsuyuki KITAJIMA, Kanagawa (JP); Michio TAKE, Kanagawa (JP)

(72) Inventors: Yutaka SAITO, Kanagawa (JP); Sakon TAKAHASHI, Kanagawa (JP); Katsuyuki KITAJIMA, Kanagawa (JP); Michio TAKE, Kanagawa (JP)

(73) Assignee: FUJI XEROX CO., LTD., Tokyo (JP)

(21) Appl. No.: 13/351,783

(22) Filed: Jan. 17, 2012

(30) Foreign Application Priority Data
Sep. 16, 2011 (JP) 2011-203247

(51) Int. Cl. G03G 9/00; G03G 15/08

(52) U.S. Cl. 430/105; 430/111.4; 430/108.7; 977/773; 399/252

(57) ABSTRACT

An electrostatic charge image developing toner includes toner particles and an external additive. The toner particles have a moisture content of from 0.1 mass % to 5.0 mass %, and the external additive has a volume average particle diameter of from about 70 nm to about 400 nm and an average circularity of from 0.5 to 0.9.

### CROSS-REFERENCE TO RELATED APPLICATIONS

This application is based on and claims priority under 35 USC 119 from Japanese Patent Application No. 2011-203247 filed Sep. 16, 2011.

### BACKGROUND

1. Technical Field

The present invention relates to an electrostatic charge image developing toner, an electrostatic charge image developer, a toner cartridge, a process cartridge, an image forming apparatus, and an image forming method.

2. Related Art

Generally, in an electrophotographic method, images are formed through plural processes including: electrically forming a latent image on a surface of a photoreceptor (electrostatic latent image holding member) using a photoconductive material by various means; developing the formed latent image by using a developer containing a toner to form a developed image; transferring the developed image to a surface of a transfer member such as a sheet via an intermediate transfer member if it is necessary; and fixing the transferred image by heating, pressing, heating and pressing or the like.

### SUMMARY

According to an aspect of the invention, there is provided an electrostatic charge image developing toner including: toner particles; and an external additive, in which the toner particles have a moisture content of from 0.1 mass % to 5.0 mass %, and the external additive has a volume average particle diameter of from about 70 nm to about 400 nm and an average circularity of from 0.5 to 0.9.

### BRIEF DESCRIPTION OF THE DRAWINGS

Exemplary embodiments of the present invention will be described in detail based on the following figures, wherein:

FIG. 1 is a diagram schematically showing the configuration of an example of an image forming apparatus according to an exemplary embodiment; and

FIG. 2 is a diagram schematically showing the configuration of an example of a process cartridge according to the exemplary embodiment.

### DETAILED DESCRIPTION

Hereinafter, exemplary embodiments of the invention will be described in detail.

[Electrostatic Charge Image Developing Toner]

An electrostatic charge image developing toner according to this exemplary embodiment (hereinafter, simply referred to as “toner”) includes toner particles and an external additive.

The toner particles have a moisture content of from 0.1 mass % to 5.0 mass % (or from about 0.1 mass % to about 5.0 mass %).

The external additive has a volume average particle diameter of from 70 nm to 400 nm (or from about 70 nm to about 400 nm), and an average circularity of from 0.5 to 0.9 (or from about 0.5 to about 0.9).

Due to the above-described configuration, the toner according to this exemplary embodiment allows the generation of color stripes to be inhibited while preventing the abrasion of an electrostatic latent image holding member (for example, electrophotographic photoreceptor).

The reason for this is not clear, but may be as follows.

First, in the past, for the purpose of inhibiting the passing of the external additive in the toner particles by a mechanical load, a large-diameter external additive having a spherical shape has been used as the external additive.

However, when a large-diameter external additive having a spherical shape is used, the external additive passes through a contacting portion between a cleaning blade and an electrostatic latent image holding member and color stripes may be generated. Particularly, when the same pattern images having a low image density are continuously printed under the low temperature and low humidity environment, the external additive is not easily remained in a contacting portion between the cleaning blade and the electrostatic latent image holding member at a position of non-imaging portion, whereby the above phenomenon easily occurs noticeably.

Meanwhile, when the external additive is irregular, the scraping property with respect to the cleaning blade is improved, and thus it is thought that the passing of the external additive from the contacting portion between the cleaning blade and the electrostatic latent image holding member is inhibited.

However, when the external additive is irregular, a contacting area of the external additive to the toner particles is reduced, and thus the external additive is easily released from the toner particles, and as a result, the external additive is excessively supplied to the contacting portion between the cleaning blade and the electrostatic latent image holding member. As a result, the abrasion of the electrostatic latent image holding member tends to increase.

In this exemplary embodiment, an external additive is employed that has a volume average particle diameter (70 nm to 400 nm) to have a function (spacer function) as an external additive and to be hardly released from the toner particles, and is irregular (average circularity of from 0.5 to 0.9) for the purpose of inhibiting the passing of the external additive from the contacting portion between the cleaning blade and the electrostatic latent image holding member.

By combining the irregular-shape external additive and the toner particles holding appropriate moisture (toner particles having a moisture content in the above-described range), the adhesion force of the irregular-shape external additive to the toner particles is improved due to a liquid cross-linking force of the moisture present on the surfaces of the toner particles, and thus it is thought that the release of the irregular-shape external additive from the toner particles is inhibited.

Accordingly, the toner according to this exemplary embodiment is thought to facilitate the inhibition of the generation of color stripes while preventing the abrasion of the electrostatic latent image holding member.

Hereinafter, the configuration of a toner according to this exemplary embodiment will be described in detail.

(Toner Particles)

Toner particles have a moisture content of from 0.1 mass % to 5.0 mass % (or from about 0.1 mass % to about 5.0 mass %) preferably from 0.3 mass % to 3.5 mass % (or from about 0.3 mass % to about 3.5 mass %), and more preferably from 0.5 mass % to 2.0 mass % (or from about 0.5 mass % to about 2.0 mass %).

By adjusting the moisture content of toner particles to 0.1 mass % or greater, the liquid cross-linking force of the moisture present on the surfaces of the toner particles is not easily exhibited, and thus the adhesion force of the external additive to the toner particles is reduced and the release of the external additive is inhibited.

By adjusting the moisture content of toner particles to 5.0 mass % or less, the embed of the external additive due to a reduction in the surface hardness of the toner particles by holding an excessive amount of moisture is inhibited.

As a method of adjusting the moisture content of toner particles to the above-described range, for example, a melt suspension method, an emulsion aggregation and coalescence method, a dissolution suspension method or the like, which have been known, is employed, and examples thereof include a method of adjusting a drying temperature and a drying time of toner particles.

The moisture content of toner particles is measured by a constant-voltage polarization-voltage titration method by using a Karl Fischer titrator with a toner left for 24 hours under the environment of 22.5° C./50% RH. For example, the moisture content is measured by a capacity titration-type moisture content measuring device KF-06 manufactured by Mitsubishi Chemical industries Ltd. That is, 10 μl of pure water is precisely weighed by a microsyringe, and the moisture (mg) per 1 ml of a Karl Fischer reagent is calculated by the titer of the reagent necessary for removing the water. Next, a measurement sample is precisely weighed in the range of 100 mg to 200 mg and sufficiently dispersed in a measurement flask for 5 minutes by a magnetic stirrer. After the dispersion, the measurement is started and the titer (ml) of the Karl Fischer reagent required for the titration is integrated to calculate a moisture amount and a moisture content by the following expressions and to express a Karl Fischer moisture content by the moisture content.

Moisture Amount (mg)=Reagent Consumption (ml)×Reagent Titer (mg H₂O/ml)

Moisture Content (%)=[Moisture Amount (mg)/Sample Amount (mg)]×100

Specifically, toner particles include, for example, a binder resin, and if necessary, a colorant, a release agent and other additives.

The binder resin is not particularly limited, but examples thereof include homopolymers of monomers such as styrenes such as styrene, parachlorostyrene and α-methylstyrene; esters having a vinyl group such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate and 2-ethylhexyl methacrylate; vinylnitriles such as acrylonitrile and methacrylonitrile; vinyl ethers such as vinyl methyl ether and vinyl isobutyl ether; vinyl ketones such as vinyl methyl ketone, vinyl ethyl ketone and vinyl isopropenyl ketone; and polyolefins such as ethylene, propylene and butadiene; copolymers of two or more of the monomers; and mixtures thereof. The examples also include non-vinyl condensed resins such as an epoxy resin, a polyester resin, a polyurethane resin, a polyamide resin, a cellulose resin and a polyether resin, mixtures thereof with the vinyl resins, graft polymers obtained by the polymerization of vinyl monomers in the presence thereof.

The styrene resin, (meth)acrylic resin, and styrene-(meth)acrylic copolymer resin are obtained by a known method by using, for example, a styrene monomer and a (meth)acrylic acid monomer singly or in appropriate combination. The “(meth) acryl” is an expression including any of “acryl” and “methacryl”.

The polyester resin is obtained by selecting and combining an appropriate one of a dicarboxylic acid component and a diol component and performing synthesization by using a conventionally known method such as an ester exchange method or a polycondensation method.

When the styrene resin, (meth)acrylic resin, and copolymer resin thereof are used as a binder resin, a resin having a weight average molecular weight Mw in the range of from 20,000 to 100,000 and a number average molecular weight Mn in the range of from 2,000 to 30,000 is preferably used. When the polyester resin is used as a binder resin, a resin having a weight average molecular weight Mw in the range of from 5,000 to 40,000 and a number average molecular weight Mn in the range of from 2,000 to 10,000 is preferably used.

The glass-transition temperature of the binder resin is preferably in the range of from 40° C. to 80° C. When the glass-transition temperature is in the above-described range, the minimum fixing temperature is easily maintained.

The colorant is not particularly limited as long as it is a known colorant. Examples thereof include carbon black such as farness black, channel black, acetylene black and thermal black, inorganic pigments such as colcothar, Prussian blue and titanium oxide, azo pigments such as Fast yellow, disazo yellow, pyrazolone red, chelate red, brilliant carmine and para Brown, phthalocyanine pigments such as copper phthalocyanine and metal-free phthalocyanine, and polycyclic dyes such as flavanthrone yellow, dibromoanthrone orange, perylene red, quinacridone red and dioxazine violet.

Particularly, among the colorants, azo-based pigments are preferably used from the point of view that the amount of azo-based pigment does not become very much smaller than the moisture amount of the toner. The reason for this is thought that since an azo group portion has a hydrophilic property, the moisture may be maintained to a certain level through an interaction with a hydrophilic group portion of the binder resin.

That is, from the point of view of preventing the abrasion of the electrostatic latent image holding member and inhibiting the generation of color stripes, it is preferable that the toner according to this exemplary embodiment has an aspect of a magenta toner having magenta toner particles containing an azo-based pigment.

Preferred examples of the azo-based pigments include disazo-based pigments such as C.I. Pigment Red 37, C.I. Pigment Red 38, C.I. Pigment Red 41, C.I. Pigment Red 111 and C.I. Pigment Orange 13, C.I. Pigment Orange 15, C.I. Pigment Orange 16, C.I. Pigment Orange 34, C.I. Pigment Orange 44 and condensed disazo-based pigments such as C.I. Pigment Red 144, C.I. Pigment Red 166, C.I. Pigment Red 214, C.I. Pigment Red 220, C.I. Pigment Red 221, C.I. Pigment Red 242, C.I. Pigment Red 248, C.I. Pigment Red 262 and C.I. Pigment Orange 31.

Regarding the colorant, if necessary, a surface-treated colorant may be used and a dispersant may be used in combination. Various kinds of colorants may be used in combination.

The content of the colorant is preferably in the range of from 1 mass % to 30 mass % with respect to the total mass of the binder resin.

Examples of the release agent include hydrocarbon-based wax; natural wax such as carnauba wax, rice wax and candelilla wax; synthetic or mineral and petroleum-based wax such as montan wax; ester-based wax such as fatty acid ester and montanic acid ester; and the like. However, the release agent is not limited thereto.

From the point of view of preservability, the melting point of the release agent is preferably 50° C. or higher, and more preferably 60° C. or higher. In addition, from the point of view of offset resistance, the melting point is preferably 110° C. or lower, and more preferably 100° C. or lower.

The content of the release agent is preferably from 1 mass % to 15 mass %, more preferably from 2 mass % to 12 mass %, and even more preferably from 3 mass % to 10 mass %.

Examples of other additives include a magnetic material, a charge-controlling agent, an inorganic powder and the like.

The shape factor SF1 of toner particles may be from 125 to 140 (preferably from 125 to 135, and more preferably from 130 to 135), and the shape factor SF2 may be from 105 to 130 (preferably from 110 to 125, and more preferably from 115 to 120).

The shape factor SF1 of toner particles is obtained by the following expression.

Expression: Shape Factor SF1=(ML²/A)×(π/4)×100

In the expression, ML represents an absolute maximum length of the toner particle, and A represents a projection area of the toner particle.

The shape factor SF1 is mainly quantified by analyzing a microscope image or an electron scanning microscope (SEM) image by using an image analyzer, and may be calculated as follows. That is, an optical photomicrograph of toner particles applied to a glass slide surface is taken in a LUZEX image analyzer through a video camera to obtain the maximum lengths and the projection areas of 100 toner particles and calculate shape factors by the above-described expression, and an average value thereof is obtained, whereby the shape factor SF1 is obtained.

The shape factor SF2 of toner particles is obtained as follows.

Toner particles are observed by using a scanning electron microscope (for example: S-4100 manufactured by Hitachi, Ltd.), and an image is photographed. The image is taken in an image analyzer (for example, LUZEX III manufactured by Nireco Corporation), and SF2 of each of 100 toner particles is calculated on the basis of the following expression. An average value thereof is obtained and set as the shape factor SF2. The magnification of the electron microscope is adjusted so that about 3 to 20 external additives are taken in one field of view. SF2 is calculated on the basis of the following expression with the observation of plural fields of view.

Expression: Shape Factor SF2=[PM²/(4×A×π)]×100

Here, in the expression, PM represents a boundary length of the toner particle. A represents a projection area of the toner particle. π represents circular constant.

The volume average particle diameter of toner particles is preferably from 2 μm to 10 μm, and more preferably from 4 μm to 8 μm.

The volume average particle diameter of toner particles is measured by Coulter Multisizer-II (manufactured by Beckman Coulter, Inc.) with an aperture diameter of 50 μm. At this time, the measurement is carried out after toner particles are dispersed in an electrolyte aqueous solution (ISOTON solution) using ultrasonic waves for 30 seconds or longer.

In the measurement, 0.5 mg to 50 mg of a measurement sample is added to 2 ml of a 5% aqueous solution containing a surfactant, preferably alkylbenzene sodium sultanate, as a dispersant, and the mixture is added to 100 ml to 150 ml of the electrolyte. The electrolyte containing the measurement sample suspended therein is subjected to a dispersion treatment using an ultrasonic disperser for about 1 minute, and the particle size distribution of particles is measured. The number of particles to be measured is 50,000.

The measured particle size distribution is accumulated to draw a cumulative distribution from the smallest diameter side for the volume in divided particle size ranges (channels), and the particle diameter corresponding to 50% in the cumulative distribution is defined as the volume average particle diameter.

(External Additive)

The external additive has a volume average particle diameter of from 70 nm to 400 nm, and an average circularity of from 0.5 to 0.9.

The volume average particle diameter of the external additive is from 70 nm to 400 nm (or from about 70 nm to about 400 nm), preferably from 100 nm to 350 nm (or from about 100 nm to about 350 nm), and more preferably from 100 nm to 250 nm (or from about 100 nm to about 250 nm).

By adjusting the volume average particle diameter of the external additive to 70 nm or greater, a function (spacer function) as the external additive is obtained.

By adjusting the volume average particle diameter of the external additive to 400 nm or less, the release from the toner particles and defects by a mechanical load are inhibited.

Regarding the volume average particle diameter of the external additive, 100 primary particles of silica particles after dispersion of the silica particles in the toner particles are observed using a scanning electron microscope (SEM) device, the maximum length and the minimum length of each particle are measured by image analysis of the primary particles, and from an intermediate value therebetween, the sphere-equivalent diameter is measured. The 50% diameter (D50v) in the cumulative frequency of the obtained sphere-equivalent diameter is set as the volume average particle diameter of the external additive.

The average circularity of the external additive is from 0.5 to 0.9, and preferably from 0.5 to 0.8.

By adjusting the average circularity of the external additive to 0.5 or greater, the concentration of stress is inhibited when a mechanical load is applied, and defects by a mechanical load are prevented.

By adjusting the average circularity of the external additive to 0.9 or less, the external additive has an irregular shape, and the passing of the external additive at the contacting portion between the cleaning blade and the electrostatic latent image holding member is inhibited.

The circularity of the external additive is obtained as “100/SF2”, that is calculated by the following expression, from the analysis of an image of the primary particles obtained by observing the primary particles of the external additive after dispersion of the silica particles in the toner particles by using a SEM device.

Circularity (100/SF2)=4π×(A/I²)

In the expression, I represents a boundary length of the primary particle of the silica particle on the image, and A represents a projection area of the primary particle of the external additive. SF2 represents a shape factor.

The average circularity of the external additive is obtained as a 50% circularity in the cumulative frequency of the equivalent circle diameter of the 100 primary particles obtained by the above-described image analysis.

The standard deviation of the circularity of the external additive may be 0.3 or less (or about 0.3 or less), preferably 0.2 or less (or about 0.2 or less), and more preferably 0.1 or less (or about 0.1 or less).

By adjusting the standard deviation of the circularity of the external additive to 0.3 or less, the ratio of the external additive having a same circularity in the entire external additive easily increases. As a result, the uneven abrasion of the electrostatic latent image holding member by the external additive is easily inhibited. The reason for this is thought that when the circularity of the external additive varies, the degree of the abrasion of the electrostatic; latent image holding member also varies, and thus when the ratio of the external additive having a same circularity in the entire external additive increases, the degree of the abrasion is uniformized.

Regarding the standard deviation of the circularity of the external additive, the circularity of the external additive is obtained in accordance with the above description, and with respect to the obtained circularity of the external additive, a square sum of a difference between the circularity of each external additive and the average circularity is obtained and divided by the number of all of external additive particles. The square root of the resultant value is taken and calculated as the standard deviation.

Examples of the external additive include known external additives such as inorganic particles and organic particles, that satisfy the above-described characteristics. Examples of the inorganic particles include all of particles, that are generally used as an external additive of a toner surface, of silica (for example, fumed silica, sol-gel silica and the like), alumina, titania, zinc oxide, tin oxide, iron oxide, calcium carbonate, magnesium carbonate, tricalcium phosphate, cerium oxide, and the like.

Examples of the organic particles include all of particles, that are generally used as an external additive of a toner surface, of a vinyl-based resin, a polyester resin, a silicone resin, a fluorine-based resin, and the like.

These additives may be subjected to a surface hydrophobization treatment.

Among these external additives, silica particles are preferably used as an external additive.

The silica particles may be produced by, for example, a method of obtaining silica sol by using liquid glass as a raw material or a so-called wet method of forming particles by a sol-gel method by using a silicon compound typified by alkoxysilane as a raw material. However, from the point of view of obtaining irregular-shape silica particles satisfying the above-described characteristics, the silica particles is preferably obtained by the following silica particle producing method (hereinafter, referred to as the silica particle producing method).

Hereinafter, the silica particle producing method will be described.

The silica particle producing method has a process of preparing an alkali catalytic solution that contains an alkali catalyst at a concentration of from 0.6 mol/L to 0.87 mol/L (or from about 0.6 mol/L to about 0.87 mol/L) in a solvent containing alcohol (hereinafter, referred to as “alkali catalytic solution preparation process” in some cases) and a process of supplying tetraalkoxysilane to the alkali catalytic solution and supplying an alkali catalyst in an amount of from 0.1 mol to 0.4 mol (or from about 0.1 mol to about 0.4 mol) per 1 mol of the total supply amount of tetraalkoxysilane that is supplied per minute (hereinafter, referred to as “particle forming process” in some cases).

That is, in the silica particle producing method, in the presence of the alcohol that contains an alkali catalyst at the above-described concentration, tetraalkoxysilane that is a raw material and a separate alkali catalyst that is a catalyst are supplied to form the above-described relationship therebetween, and the tetraalkoxysilane is reacted to form silane particles.

In the silica particle producing method, by the above-described method, it is possible to obtain irregular-shape silica particles satisfying the above-described characteristics with less generation of coarse aggregates.

Particularly, in the silica particle producing method, since irregular-shape round silica particles, of which the surfaces are configured in a curved shape, are obtained, a contacting area to the toner particles increases in comparison to the case of irregular-shape silica particles, of which the surfaces obtained by a dry preparation method have a sharp angle-shaped protrusion. In addition, even when the silica particles have an irregular shape, the release from the toner particles is easily inhibited, or defects by a mechanical load are easily inhibited. As a result, the abrasion of the electrostatic latent image holding member is prevented and the generation of color stripes is easily inhibited.

The reason for this is not clear, but may be as follows.

First, an alkali catalyst solution that contains an alkali catalyst in a solvent containing alcohol is prepared, and when tetraalkoxysilane and an alkali catalyst are supplied to this solution, the tetraalkoxysilane supplied to the alkali catalyst solution is reacted and core particles are formed. At this time, when the concentration of the alkali catalyst in the alkali catalyst solution is in the above-described range, it is thought that core particles having a low circularity are formed while the formation of coarse aggregates such as secondary aggregates is inhibited. The reason for this is thought that in addition to the catalyst action, the alkali catalyst is coordinated to the surfaces of the formed core particles and contributes to the shape and dispersion stability of the core particles, but when the amount thereof is in the above-described range, the alkali catalyst does not uniformly cover the surfaces of the core particles (that is, the alkali catalyst unevenly adheres to the surfaces of the core particles), and thus the dispersion stability of the core particles is held, but partial deviation occurs in the surface tension and the chemical affinity of the core particles and core particles having a low circularity are formed.

In addition, when the tetraalkoxysilane and the alkali catalyst are continuously supplied, the formed core particles are grown due to the reaction of the tetraalkoxysilane, and silane particles are obtained. Here, it is thought that by supplying the tetraalkoxysilane and the alkali catalyst while maintaining the supply amounts thereof to form the above-described relationship therebetween, the formation of coarse aggregates such as secondary aggregates is inhibited, core particles having a low circularity are grown while the irregularity thereof is maintained, and as a result, silica particles having a low circularity are formed. The reason for this is thought that by forming the above-described relationship between the supply amounts of the tetraalkoxysilane and the alkali catalyst, the dispersion of the core particles is held, and partial deviation in the tension and the chemical affinity of the core particle surfaces is held, whereby the core particles are grown while maintaining the irregularity.

From the above description, it is thought that in the silica particle producing method, it is possible to obtain irregular-shape silica particles with less generation of coarse aggregates.

In addition, it is thought that in the silica particle producing method, since the core particles are grown while maintaining the irregularity, it is possible to obtain irregular-shape round silica particles, of which the surfaces are configured in a curved shape.

Here, it is thought that the supply amount of tetraalkoxysilane relates to the particle size distribution and the circularity of silica particles. It is thought that by adjusting the supply amount of tetraalkoxysilane to be equal to or greater than 0.002 mol/(mol·min) and less than 0.0055 mol/(mol·min), the probability of contact between the dropped tetraalkoxysilane and the core particles is lowered, and thus before the reaction of tetraalkoxysilane occurs, the tetraalkoxysilane is supplied to the core particles without deviation. Accordingly, it is thought that it is possible to cause the reaction of the tetraalkoxysilane with the core particles without deviation. As a result, it is thought that a variation in the particle growth is inhibited and it is possible to produce silica particles with a narrow distribution width.

It is thought that the volume average particle diameter of the silica particles depends on the total supply amount of tetraalkoxysilane.

In addition, in the silica particle producing method, since it is thought that irregular-shape core particles are formed and grown while maintaining the irregular shape thereof and silica particles are thus formed, it is thought that it is possible to obtain irregular-shape silica particles having high shape stability associated with a mechanical load.

In addition, in the silica particle producing method, since it is thought that the irregular-shape core particles that are formed are grown while maintaining the irregular shape and silica particles are thus obtained, it is thought that it is possible to obtain silica particles that have strong resistance to a mechanical load and are not easily crushed.

In addition, in the silica particle producing method, by supplying tetraalkoxysilane and an alkali catalyst to an alkali catalyst solution, the tetraalkoxysilane is reacted and thus particles are formed. Accordingly, a total amount of alkali catalyst used is reduced in comparison to the case of producing irregular-shape silica particles by a conventional sol-gel method, and as a result, the omission of the alkali catalyst removing process is also realized. This is particularly favorable when the silica particles are applied to products requiring high purity.

Next, the alkali catalytic solution preparation process will be described.

In the alkali catalytic solution preparation process, a solvent containing alcohol is prepared, and an alkali catalyst is added thereto to prepare an alkali catalyst solution.

The solvent containing alcohol may be a single solvent of alcohol, or if necessary, a mixed solvent with other solvents such as water, ketones such as acetone, methyl ethyl ketone and methyl isobutyl ketone, cellosolves such as methyl cellosolve, ethyl cellosolve, butyl cellosolve and cellosolve acetate, and ethers such as dioxane and tetrahydrofuran.

In the case of the mixed solvent, the amount of alcohol with respect to other solvents may be 80 mass % or greater (preferably 90 mass % or greater).

Examples of the alcohol include lower alcohol such as methanol and ethanol.

The alkali catalyst is a catalyst for promoting the reaction (hydrolysis reaction, condensation reaction) of tetraalkoxysilane. Examples thereof include basic catalysts such as ammonia, urea, monoamine and quaternary ammonium salt, and particularly, ammonia is preferably used.

The concentration (content) of the alkali catalyst is from 0.6 mol/L to 0.87 mol/L, preferably from 0.63 mol/L to 0.78 mol/L, and more preferably from 0.66 mol/L to 0.75 mol/L.

When the concentration of the alkali catalyst is less than 0.6 mol/L, the dispersibility of core particles in the course of growing the formed core particles becomes unstable, and thus coarse aggregates such as secondary aggregates are formed or gelation occurs, whereby the particle size distribution may deteriorate.

On the other hand, when the concentration of the alkali catalyst is greater than 0.87 mol/L, the stability of the formed core particles excessively increases, and thus spherical core particles are formed and it may be difficult to obtain irregular-shape core particles having an average circularity of 0.90 or less.

The concentration of the alkali catalyst is a concentration with respect to an alcohol catalyst solution (alkali catalyst containing alcohol).

The particle forming process will be described.

The particle forming process is a process in which tetraalkoxysilane and an alkali catalyst are supplied to an alkali catalyst solution, and the tetraalkoxysilane is reacted (hydrolysis reaction, condensation reaction) in the alkali catalyst solution to form silica particles.

In this particle forming process, at an initial supply period of the tetraalkoxysilane, core particles are formed due to the reaction of the tetraalkoxysilane (core particle forming step), and then silica particles are formed through the growth of the core particles (core particle growing step).

Examples of the tetraalkoxysilane that is supplied to the alkali catalyst solution include tetramethoxysilane, tetraethoxysilane, tetrapropoxysilane, tetrabutoxysilane and the like. However, from the point of view of controllability of the reaction speed, and the shape, particle diameter and particle size distribution and the like of the obtained silica particles, tetramethoxysilane and tetraethoxysilane are preferably used.

The supply amount of tetraalkoxysilane is from 0.002 mol/(mol·min) to 0.0055 mol/(mol·min) with respect to the alcohol in the alkali catalyst solution.

This means that tetraalkoxysilane is supplied in a supply amount of from 0.002 mol/(mol·min) to 0.0055 mol/(mol·min) per minute with respect to 1 mol of the alcohol used in the process of preparing the alkali catalyst solution.

Regarding the particle diameter of the silica particles, depending on the kind of tetraalkoxysilane and the reaction condition, the total supply amount of tetraalkoxysilane that is used in the particle formation reaction is adjusted to 0.756 mol or greater with respect to, for example, 1 L of a silica particle dispersion liquid to obtain primary particles having a particle diameter of 70 nm or greater, and is adjusted to 4.4 mol or less with respect to 1 L of a silica particle dispersion liquid to obtain primary particles having a particle diameter of 400 nm or less.

When the supply amount of tetraalkoxysilane is less than 0.002 mol/(mol·min), the probability of contact between the dropped tetraalkoxysilane and the core particles is lowered. However, a long period of time is required until dropping of the total supply amount of tetraalkoxysilane ends, and the production efficiency deteriorates.

When the supply amount of tetraalkoxysilane is greater than 0.0055 mol/(mol·min), it is thought that the reaction of the tetraalkoxysilane occurs before the reaction between the dropped tetraalkoxysilane and the core particles. Therefore, uneven supply of tetraalkoxysilane to the core particles is facilitated and a variation in the formation of the core particles is caused, whereby the distribution width of the shape distribution is expanded and it may be difficult to produce silica in which the standard deviation of the circularity is 0.3 or less.

The supply amount of tetraalkoxysilane is preferably from 0.002 mol/(mol·min) to 0.0045 mol/(mol·min), and more preferably from 0.002 mol/(mol·min) to 0.0035 mol/(mol·min).

Examples of the alkali catalyst that is supplied to the alkali catalyst solution include the above-described examples. The alkali catalyst to be supplied may be the same kind as or a different kind from the alkali catalyst that is contained in advance in the alkali catalyst solution, but the same kind is preferably used.

The supply amount of an alkali catalyst is from 0.1 mol to 0.4 mol per 1 mol of the total supply amount of tetraalkoxysilane that is supplied per minute, preferably from 0.14 mol to 0.35 mol, and more preferably from 0.18 mol to 0.30 mol.

When the supply amount of an alkali catalyst is less than 0.1 mol, the dispersibility of core particles in the course of growing the formed core particles becomes unstable, and thus coarse aggregates such as secondary aggregates are formed or gelation occurs, whereby the particle size distribution may deteriorate.

On the other hand, when the supply amount of an alkali catalyst is greater than 0.4 mol, the stability of the formed core particles excessively increases. Accordingly, even when core particles having a low circularity are formed in the core particle forming step, the core particles are grown into a spherical shape in the core particle growing step and silica particles having a low circularity are not obtained in some cases.

Here, in the particle forming process, tetraalkoxysilane and an alkali catalyst are supplied to an alkali catalyst solution, but this supply method may be a continuous supply method or an intermittent supply method.

In addition, in the particle forming process, the temperature (temperature at the time of supply) in an alkali catalyst solution may be, for example, from 5° C. to 50° C., and preferably in the range of from 15° C. to 40° C.

Through the above-described processes, silica particles are obtained. In this state, the obtained silica particles are obtained in a state of a dispersion liquid, but are taken out and used as a powder of silica particles by removing the solvent.

Examples of the method of removing the solvent of the silica particle dispersion liquid include known methods such as 1) a method of removing a solvent by filtration, centrifugation, distillation or the like, and then performing drying by a vacuum dryer, a tray dryer or the like and 2) a method of directly drying a slurry by a fluid-bed dryer, a spray dryer or the like. The drying temperature is not particularly limited, but is preferably 200° C. or lower. When the drying temperature is higher than 200° C., bonding between primary particles due to the condensation of a silanol group remaining on a silica particle surface, and the generation of coarse particles easily occur.

The dried silica particles are, if necessary, cracked, and coarse particles and aggregates may be removed by sieving. The cracking method is not particularly limited, but is, for example, performed by a dry pulverizer such as a jet mill, a vibration mill, a ball mill or a pin mill. The sieving method is, for example, performed by a known machine such as a vibration sieve or a wind classifier.

Here, the silica particles obtained by the silica particle producing method may be subjected to a surface hydrophobization treatment by a hydrophobization treatment agent to be used.

Examples of the hydrophobization treatment agent include a known organic silicon compound having an alkyl group (for example, a methyl group, an ethyl group, a propyl group, a butyl group and the like). Specific examples thereof include a silazane compound (for example, silane compounds such as methyltrimethoxysilane, dimethyldimethoxysilane, trimethylchlorosilane and trimethylmethoxysilane, hexamethyldisilazane, tetramethyldisilazane, and the like). The hydrophobization treatment agents may be used alone or in combination of plural kinds thereof.

Among these hydrophobization treatment agents, an organic silicon compound having a trimethyl group such as trimethylmethoxysilane and hexamethyldisilazane is preferable.

The amount of the hydrophobization treatment agent used is not particularly limited. However, in order to obtain a hydrophobization effect, the amount is 1 mass % to 100 mass % with respect to the silica particles, and preferably 5 mass % to 80 mass %.

Examples of the method of obtaining a hydrophobic silica particle dispersion liquid subjected to a hydrophobization treatment by a hydrophobization treatment agent include a method in which silica particles are subjected to a hydrophobization treatment by adding a necessary amount of a hydrophobization treatment agent to a silica particle dispersion liquid and causing the reaction at a temperature range of from 30° C. to 80° C. under the stirring to obtain a hydrophobic silica particle dispersion liquid. When the reaction temperature is lower than 30° C., the hydrophobization reaction does not easily proceed, and at a temperature higher than 80° C., the gelation of the dispersion liquid by self-condensation of the hydrophobization treatment agent and the aggregation of the silica particles to each other may easily occur.

Examples of the method of obtaining powdery hydrophobic silica particles include a method in which a hydrophobic silica particle dispersion liquid is obtained by the above-described method, and then is dried by the above-described method to obtain a powder of hydrophobic silica particles, a method in which a silica particle dispersion liquid is dried to obtain a powder of hydrophilic silica particles, and then a hydrophobization treatment agent is added to subject the powder to a hydrophobization treatment so as to obtain a powder of hydrophobic silica particles, a method in which a hydrophobic silica particle dispersion liquid is obtained and then dried to obtain a powder of hydrophobic silica particles, and then a hydrophobization treatment agent is added to subject the powder to a hydrophobization treatment so as to obtain a powder of hydrophobic silica particles, and the like.

Here, examples of the method of subjecting powdery silica particles to a hydrophobization treatment include a method in which powdery hydrophilic silica particles are stirred in a Henschel mixer or a treatment vessel such as a fluid bed, a hydrophobization treatment agent is added thereto, and the inside of the treatment vessel is heated to gasify the hydrophobization treatment agent so as to be reacted with a silanol group on a silica particle surface of the powder. The treatment temperature is not particularly limited, but for example, may be from 80° C. to 300° C., and preferably from 120° C. to 200° C.

The above-described external additive is preferably added in an amount of from 0.5 part by mass to 5.0 parts by mass with respect to 100 parts by mass of toner particles to be described later, more preferably from 0.7 part by mass to 4.0 parts by mass, and even more preferably from 0.9 part by mass to 3.5 parts by mass (or from about 0.9 part by mass to about 3.5 parts by mass).

Next, a method of producing the toner according to this exemplary embodiment will be described.

The toner according to this exemplary embodiment is obtained by producing toner particles and then externally adding an external additive as an external additive to the toner particles.

As a method of producing toner particles, a wet granulation method is preferably performed. Examples of the wet granulation method include a melt suspension method, an emulsion aggregation and coalescence method, a dissolution suspension method and the like, which have been known.

Examples of the method of externally adding an external additive to the obtained toner particles include a mixing method by a known mixer such as a V-shaped blender, a Henschel mixer or a Lödige mixer.

[Electrostatic Charge Image Developer]

An electrostatic charge image developer according to this exemplary embodiment contains at least a toner according to this exemplary embodiment.

An electrostatic charge image developer according to this exemplary embodiment may be a single-component developer containing only a toner according to this exemplary embodiment, or a two-component developer in which the toner and a carrier are mixed.

The carrier is not particularly limited, and examples thereof include known carriers such as a resin-coated carrier, a magnetism dispersion-type carrier and a resin dispersion-type carrier.

The mixing ratio (mass ratio) between the toner according to this exemplary embodiment and the carrier in the two-component developer is preferably in the range of about 1:100 to 30:100 (toner:carrier), and more preferably in the range of about 3:100 to 20:100.

[Image Forming Apparatus and Image Forming Method]

Next, an image forming apparatus and an image forming method according to this exemplary embodiment using a toner according to this exemplary embodiment will be described.

An image forming apparatus according to this exemplary embodiment includes: an electrostatic latent image holding member; a charging unit that charges a surface of the electrostatic latent image holding member; an electrostatic latent image forming unit that forms an electrostatic latent image on the surface of the electrostatic latent image holding member; a developing unit that contains a developer for electrostatic charge development according to this exemplary embodiment and develops the electrostatic latent image formed on the surface of the electrostatic latent image holding member by the developer to form a toner image; and a transfer unit that transfers the toner image onto a transfer medium (recording medium). The image forming apparatus may further include a fixing unit that fixes the toner image of the recording medium; and a cleaning unit that has a cleaning blade that is brought into contact with the surface of the electrostatic latent image holding member after transfer of the toner image and cleans the surface.

According to the image forming apparatus according to this exemplary embodiment, an image forming method is performed that includes: charging a surface of the electrostatic latent image holding member; forming an electrostatic latent image on the charged surface of the electrostatic latent image holding member; developing the electrostatic latent image formed on the surface of the electrostatic latent image holding member by using a developer for electrostatic charge development according to this exemplary embodiment to form a toner image; and transferring the developed toner image onto a transfer medium (recording medium). The image forming method may further include fixing the toner image of the recording medium; and cleaning the surface of the electrostatic latent image holding member by a cleaning blade that is brought into contact with the above surface after transfer of the toner image.

For example, the image formation by the image forming apparatus according to this exemplary embodiment is performed as follows when an electrophotographic photoreceptor is used as the electrostatic latent image holding member. First, a surface of the electrophotographic photoreceptor is charged by a corotron charging device, a contact charging device or the like, and then exposed to form an electrostatic charge image. Next, the image is brought into contact with or approaches a developing roll that has a developer layer formed on a surface thereof to adhere a toner to the electrostatic latent image, and a toner image is formed on the electrophotographic photoreceptor. The formed toner image is transferred onto a surface of a recording medium such as a sheet of paper by using the corotron charging device. Furthermore, the toner image transferred onto the surface of the recording medium is fixed by the fixing device, and thus the image is formed on the recording medium. In addition, after transfer of the toner image, the surface of the electrostatic latent image holding member is cleaned by the cleaning blade, and then is charged again.

In the image forming apparatus according to this exemplary embodiment, for example, a portion including the developing unit may have a cartridge structure (toner cartridge, process cartridge or the like) that is detachably mounted on the image forming apparatus.

As the toner cartridge, for example, a toner cartridge that contains an electrostatic charge image developing toner according to this exemplary embodiment and is detachably mounted on the image forming apparatus is preferably used.

As the process cartridge, for example, a process cartridge that includes a developing unit that contains a developer for electrostatic charge development according to this exemplary embodiment and develops an electrostatic latent image formed on the surface of the electrostatic latent image holding member by the developer for electrostatic charge development to form a toner image, and is detachably mounted on the image forming apparatus is preferably used.

Hereinafter, an example of the image forming apparatus according to this exemplary embodiment will be shown, but is not limited thereto. The main portions shown in the drawing will be described, and descriptions of other portions will be omitted.

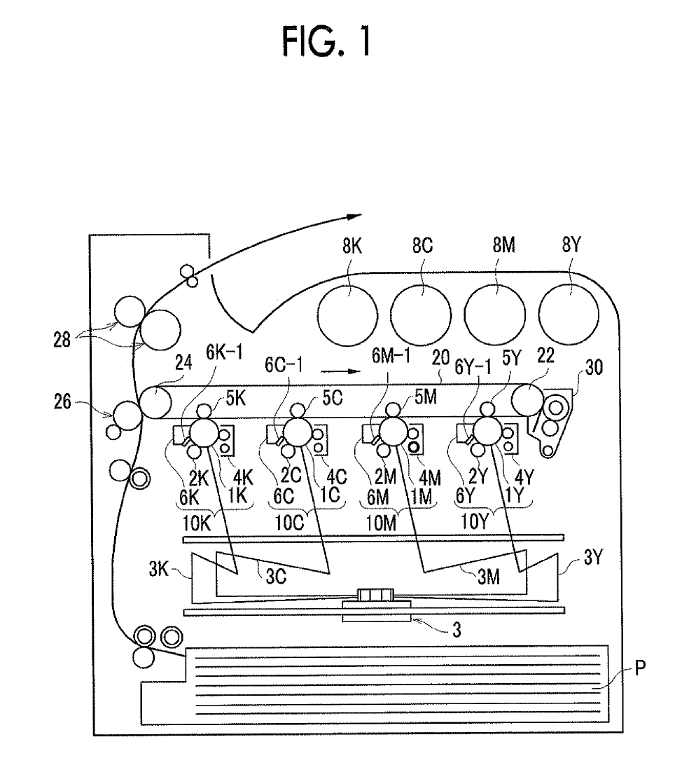

FIG. 1 is a diagram schematically showing the configuration of a 4-drum tandem color image forming apparatus. The image forming apparatus shown in FIG. 1 includes first to fourth image forming units 10Y, 10M, 10C, and 10K (image forming units) of an electrophotographic type that output color images of yellow (Y), magenta (M), cyan (C), and black (K), respectively, based on color-separated image data. The image forming units (hereinafter, simply referred to as “units” in some cases) 10Y, 10M, 10C, and 10K are arranged with a predetermined distance therebetween. The units 10Y, 10M, 10C, and 10K may be process cartridges that may be detachably mounted on the image forming apparatus body.

An intermediate transfer belt 20 as an intermediate transfer member is disposed above the units 10Y, 10M, 10C, and 10K in the drawing to extend via the units. The intermediate transfer belt 20 is wound on a driving roller 22 and a support roller 24 contacting the inner surface of the intermediate transfer belt 20, which are separated from each other on the left and right sides in the drawing, and travels in the direction toward the fourth unit 10K from the first unit 10Y. The support roller 24 is impelled in the direction in which it gets away from the driving roller 22 by a spring or the like (not shown), and thus a tension is given to the intermediate transfer belt 20 wound on both of the rollers. In addition, an intermediate transfer member cleaning device 30 opposed to the driving roller 22 is provided in a surface of the intermediate transfer belt 20 on the image holding member side.

Developing devices (developing units) 4Y, 4M, 4C, and 4K of the units 10Y, 10M, 10C, and 10K may be supplied with toners respectively including four color toners of yellow, magenta, cyan, and black contained in toner cartridges 8Y, 8M, 8C, and 8K, respectively.

The above-described first to fourth units 10Y, 10M, 10C, and 10K have the same configuration, and thus only the first unit 10Y that is used for forming a yellow image and is disposed on the upstream side in the traveling direction of the intermediate transfer belt will be representatively described. The same portions as in the first unit 10Y will be denoted by the reference numerals having magenta (M), cyan (C), and black (K) added instead of yellow (Y), and descriptions of the second to fourth units 10M, 10C, and 10K will be omitted.

The first unit 10Y includes a photoreceptor 1Y as an image holding member. Around the photoreceptor 1Y, a charging roller 2Y that charges a surface of the photoreceptor 1Y to a predetermined potential, an exposure device (electrostatic charge image forming unit) 3 that exposes the charged surface with a laser beam 3Y based on a color-separated image signal to form an electrostatic charge image, a developing device (developing unit) 4Y that supplies a charged toner to the electrostatic charge image to develop the electrostatic charge image, a primary transfer roller (primary transfer unit) 5Y that transfers the developed toner image onto the intermediate transfer belt 20, and a photoreceptor cleaning device (cleaning unit) 6Y that has a cleaning blade 6Y-1 that removes the toner remaining on the surface of the photoreceptor 1Y after the primary transfer, are arranged in sequence.

The primary transfer roller 5Y is disposed inside the intermediate transfer belt 20 and is provided at a position opposed to the photoreceptor 1Y. Bias supplies (not shown) that apply a primary transfer bias are connected to the primary transfer rollers 5Y, 5M, 5C, and 5K, respectively. The bias supplies change the transfer bias that is applied to the respective primary transfer rollers under the control of a controller (not shown).

Hereinafter, the operation of forming a yellow image in the first unit 10Y will be described. First, before the operation, the surface of the photoreceptor 1Y is charged to a potential of about −600 V to −800 V by the charging roller 2Y.

The photoreceptor 1Y is formed by stacking a photoconductive layer on a conductive substrate (volume resistivity at 20° C.: 1×10⁻⁶ Ωcm or less). This photoconductive layer typically has high resistance (resistance corresponding to the resistance of a general resin), but has a property that, when the laser beam 3Y is applied thereto, the specific resistance of a portion irradiated with the laser beam changes. Accordingly, the laser beam 3Y is output to the surface of the charged photoreceptor 1Y via the exposure device 3 in accordance with image data for yellow sent from the controller (not shown). The laser beam 3Y is applied to the photoconductive layer on the surface of the photoreceptor 1Y, whereby an electrostatic charge image of a yellow print pattern is formed on the surface of the photoreceptor 1Y.

The electrostatic charge image is an image formed on the surface of the photoreceptor 1Y by the charging, and is a so-called negative latent image that is formed because that by applying the laser beam 3Y to the photoconductive layer, the specific resistance of the irradiated portion is lowered and charges are caused to flow on the surface of the photoreceptor 1Y, and in a portion to which the laser beam 3Y is not applied, charges are caused to stay.

The electrostatic charge image that is formed in this manner on the photoreceptor 1Y is rotated to a predetermined development position with the travelling of the photoreceptor 1Y. The electrostatic charge image on the photoreceptor 1Y is visualized (to form a developed image) at the development position by the developing device 4Y.

The electrostatic charge image developer according to this exemplary embodiment including, for example, at least a yellow toner and a carrier is contained in the developing device 4Y. The yellow toner is frictionally charged by being stirred in the developing device 4Y to have a charge with the same polarity (negative polarity) as the electrified charge on the photoreceptor 1Y and is held on the developer roll (developer holding member). By allowing the surface of the photoreceptor 1Y to pass through the developing device 4Y, the yellow toner is electrostatically adhered to a latent image portion having no charge on the surface of the photoreceptor 1Y, whereby the latent image is developed with the yellow toner. Next, the photoreceptor 1Y having a yellow toner image formed thereon continuously travels at a predetermined speed, and the developed toner image on the photoreceptor 1Y is transported to a predetermined primary transfer position.

When the yellow toner image on the photoreceptor 1Y is transported to the primary transfer position, a primary transfer bias is applied to the primary transfer roller 5Y and an electrostatic force toward the primary transfer roller 5Y from the photoreceptor 1Y acts on the toner image, whereby the toner image on the photoreceptor 1Y is transferred onto the intermediate transfer belt 20. The transfer bias applied at this time has the opposite polarity (+) of the toner polarity (−) and is controlled to, for example, about +10 μA in the first unit 10Y by the controller (not shown).

On the other hand, the toner remaining on the photoreceptor 1Y is removed and collected by the cleaning blade 6Y-1 of the cleaning device 6Y.

The primary transfer biases that are applied to the primary transfer rollers 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 100, and 10K, and the toner images of respective colors are multiply transferred in a superimposed manner.

The intermediate transfer belt 20 onto which four color toner images have been multiply transferred through the first to fourth units reaches a secondary transfer portion which includes the intermediate transfer belt 20, the support roller 24 contacting the inner surface of the intermediate transfer belt, and a secondary transfer roller (secondary transfer unit) 26 disposed on the image supporting surface side of the intermediate transfer belt 20. On the other hand, a recording sheet (transfer medium) P is supplied to a gap between the secondary transfer roller 26 and the intermediate transfer belt 20, which are pressed against each other, at a predetermined timing by a supply mechanism, and a secondary transfer bias is applied to the support roller 24. The transfer bias applied at this time has the same polarity (−) as the toner polarity (−) and an electrostatic force toward the recording sheet P from the intermediate transfer belt 20 acts on the toner image, whereby the toner image on the intermediate transfer belt 20 is transferred onto the recording sheet P. The secondary transfer bias is determined depending on the resistance detected by a resistance detector (not shown) that detects the resistance of the secondary transfer portion, and is voltage-controlled.

Thereafter, the recording sheet P is fed to a pressed portion (nip portion) of a pair of fixing rolls in the fixing device (roll-like fixing unit) 28, the toner image is heated, and the color-superimposed toner image is melted and fixed onto the recording sheet P.

Examples of the transfer medium onto which the toner image is to be transferred include plain paper sheets and OHP sheets that are used in electrophotographic copiers, printers, and the like.

In order to further improve the smoothness of an image surface after the fixing, the surface of the transfer medium is preferably as smooth as possible. For example, a coated sheet obtained by coating the surface of a plain paper sheet with a resin or the like, an art paper sheet for printing or the like may be preferably used.

The recording sheet P on which the fixation of the color image has been completed is transported toward a discharge portion, and a series of color image forming operations end.

The image forming apparatus exemplified as above has a configuration in which the toner image is transferred onto the recording sheet P via the intermediate transfer belt 20. However, the invention is not limited to this configuration, and may have a configuration in which the toner image may be transferred directly onto the recording sheet from the photoreceptor.

<Process Cartridge, Toner Cartridge>

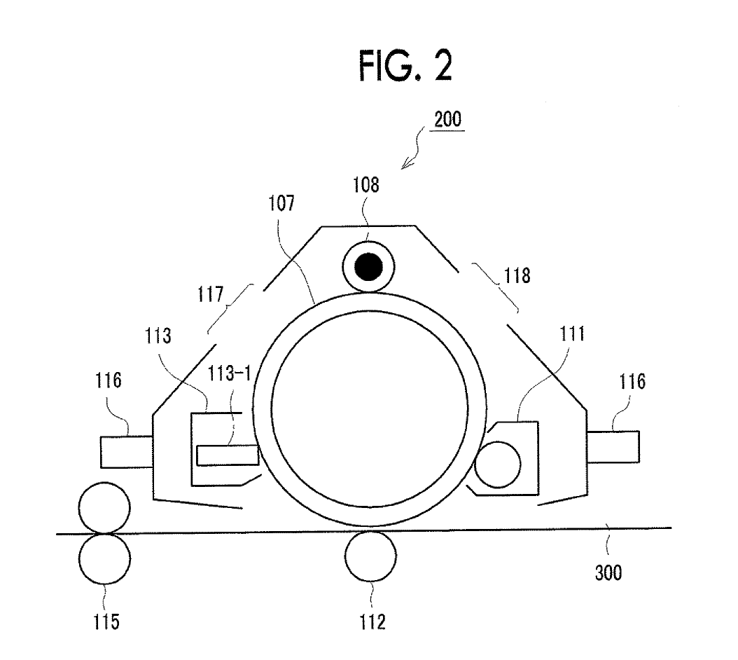

FIG. 2 is a diagram schematically showing the configuration of a preferred exemplary embodiment of an example of the process cartridge that contains the electrostatic charge image developer according to this exemplary embodiment. A process cartridge 200 has, in addition to a photoreceptor 107, a charging roller 108, a developing device 111, a photoreceptor cleaning device 113 having a cleaning blade 113-1, an opening portion 118 for exposure, and an opening portion 117 for erasing exposure that are attached thereto, and combined and integrated using a rail 116. The reference numeral 300 in FIG. 2 represents a transfer medium.

The process cartridge 200 is detachably mounted on an image forming apparatus including a transfer device 112, a fixing device 115 and other constituent portions (not shown).

The process cartridge 200 shown in FIG. 2 includes the charging device 108, the developing device 111, the cleaning device 113, the opening portion 118 for exposure, and the opening portion 117 for erasing exposure, but these devices may be selectively combined. The process cartridge according to this exemplary embodiment may include, in addition to the photoreceptor 107, at least one selected from the group consisting of the charging device 108, the developing device 111, the cleaning device (cleaning unit) 113, the opening portion 118 for exposure, and the opening portion 117 for erasing exposure.

The toner cartridge according to this exemplary embodiment will be described. The toner cartridge according to this exemplary embodiment is a toner cartridge that contains an electrostatic charge image developing toner and is detachably mounted on the image forming apparatus.

The image forming apparatus shown in FIG. 1 is an image forming apparatus that has a configuration in which the toner cartridges 8Y, 8M, 80, and 8K are detachably mounted. The developing devices 4Y, 4M, 4C, and 4K are connected to the toner cartridges corresponding to the respective developing devices (colors) via toner supply tubes (not shown). In addition, when the toner contained in a toner cartridge runs short, the toner cartridge is replaced.

### EXAMPLES

Hereinafter, this exemplary embodiment will be described in detail using Examples, but is not limited to any of these Examples. In the following description, “parts” and “%” mean “parts by mass” and “mass %”, respectively, unless particular notice is given.

[Preparation of Toner Particles]
(Toner Particles 1)
-Preparation of Polyester Resin Dispersion Liquid-

| | |
|---|---|
| Ethylene Glycol (produced by Wako Pure Chemical | 37 parts |
| Industries, Ltd.) | |
| Neopentyl Glycol (produced by Wako Pure Chemical | 65 parts |
| Industries, Ltd.) | |
| 1,9-Nonanediol (produced by Wako Pure Chemical | 32 parts |
| Industries, Ltd.) | |
| Terephthalic Acid (produced by Wako Pure Chemical | 96 parts |
| Industries, Ltd.) | |

The monomers are put into a flask and the temperature is increased up to 200° C. over 1 hour. After confirmation of the stirring inside the reaction system, 1.2 parts of dibutyl tin oxide is charged. Furthermore, the temperature is increased over 6 hours from 200° C. up to 240° C. while distilling away the generated water, a dehydration condensation reaction is further continued for 4 hours at 240° C., thereby a polyester resin A having an acid value of 9.4 mg KOH/g, a weight average molecular weight of 13,000 and a glass transition temperature of 62° C. is obtained.

Next, the polyester resin A in a melt state is delivered to CAVITRON CD1010 (produced by Eurotech Company) at a speed of 100 parts/min. Dilute ammonia water of a concentration of 0.37% that is obtained by diluting reagent ammonia water with ion exchange water is put into a separately prepared aqueous medium tank, and is delivered at a speed of 0.1 l/min to the CAVITRON together with the melted polyester resin while being heated at 120° C. by a heat exchanger. The CAVITRON is operated under the conditions of a speed of rotation of a rotor of 60 Hz and a pressure of 5 kg/cm², and thereby an amorphous polyester resin dispersion liquid in which resin particles having a volume average particle diameter of 160 nm, a solid content of 30%, a glass transition temperature of 62° C., and a weight average molecular weight Mw of 13,000 are dispersed is obtained.

-Preparation of Colorant Dispersion Liquid 1-

| | | |
|---|---|---|
| Cyan Pigment (Pigment Blue 15:3, produced by | 10 | parts |
| Dainichiseika Color & Chemicals Mfg. Co., Ltd.) | | |
| Anionic Surfactant (NEOGEN SC, produced by Dai-Ichi | 2 | parts |
| Kogyo Seiyaku Co., Ltd.) | | |
| Ion Exchange Water | 80 | parts |

The components are mixed and dispersed for 1 hour by using a high pressure impact dispersing machine Ultimizer (HJP30006, manufactured by Sugino Machine Ltd.), and thus a colorant dispersion liquid having a volume average particle diameter of 180 nm and a solid content of 20% is obtained.

-Preparation of Release Agent Dispersion Liquid-

| | | |
|---|---|---|
| Paraffin Wax (HNP-9, produced by Nippon Seiro Co., | 50 | parts |
| Ltd.) | | |
| Anionic Surfactant (NEOGEN SC, produced by Dai-Ichi | 2 | parts |
| Kogyo Seiyaku Co., Ltd.) | | |
| Ion Exchange Water | 200 | parts |

The components are heated at 120° C., and sufficiently mixed and dispersed by using ULTRA TURRAX T50 (manufactured by IKA Works Gmbh & Co. KG). Then, the mixture is subjected to a dispersion treatment by using a pressure discharge-type homogenizer, and thus a release agent dispersion liquid having a volume average particle diameter of 200 nm and a solid content of 20% is obtained.

-Preparation of Toner Particles 1-

| | | |
|---|---|---|
| Polyester Resin Dispersion Liquid | 200 | parts |
| Colorant Dispersion Liquid 1 | 25 | parts |
| Polyaluminum Chloride | 0.4 | part |
| Ion Exchange Water | 100 | parts |

The components are charged in a stainless steel flask, and sufficiently mixed and dispersed by using ULTRA TURRAX (manufactured by IKA Works Gmbh & Co. KG). Then, the mixture is heated up to 48° C. while stirring the flask by using a heating oil bath. The heated material is held at 48° C. for 30 minutes, and then 70 parts of the same polyester resin dispersion liquid as that in the above description are gradually added thereto.

Thereafter, pH in the system is adjusted to 8.0 by using a sodium hydroxide aqueous solution having a concentration of 0.5 mol/L. Then, the stainless steel flask is sealed, a seal of the stirring axis is magnetically sealed, and the system is heated up to 90° C. and held for 3 hours while the stirring is continued. After the reaction comes to completion, the system is cooled at a temperature-decrease speed of 2° C./rain, followed by filtration and thorough washing with ion exchange water, further followed by solid-liquid separation by Nutsche-type suction filtration. The resultant material is re-dispersed by using 3 L of ion exchange water having a temperature of 30° C., and is stirred and washed at 300 rpm for 15 minutes. The washing operation is further repeated six times, and when pH of the filtrate becomes 7.54 and the electric conductivity becomes 6.5 μS/cm, solid-liquid separation is performed using a No. 5A paper filter by Nutsche-type suction filtration. Next, vacuum drying is continued for 12 hours, and thus toner particles 1 are obtained.

The volume average particle diameter D50v of the toner particles 1, that is measured by a Coulter counter, is 5.8 μm, and SF1 is 130.

(Toner Particles 2)

Toner particles 2 are obtained in the same manner as in the case of the toner particles 1, except that the vacuum drying is continued for 8 hours.

(Toner Particles 3)

—Preparation of Colorant Dispersion Liquid 2—

A colorant dispersion liquid 2 is prepared in the same manner as in the case of the colorant dispersion liquid 1, except that the colorant is changed to C.I. Pigment Red 144 (condensed disazo-based pigment: produced by Ciba-Geigy K.K. Cromophtal Red BRN).

—Preparation of Toner Particles 3—

Toner particles 3 are obtained in the same manner as in the case of the toner particles 1, except that the colorant dispersion liquid 2 is used.

(Toner Particles 4)

Toner particles 4 (magenta toner particles) are obtained in the same manner as in the case of the toner particles 3, except that the vacuum drying is continued for 8 hours.

(Toner Particles 5)

83 parts by mass of the polyester resin A, 5 parts by mass of C.I. Pigment Red 144 (condensed disazo-based pigment: produced by Ciba-Geigy K.K. Cromophtal Red BRN) as a colorant, and 9 parts by mass of paraffin wax (produced by NIPPON SEIRO CO., Ltd., HNP-9, melting temperature: 75° C.) as a release agent are melted and kneaded by a Banbury kneader. The kneaded product is cooled and then coarsely pulverized. The pulverized material is further pulverized by a jet mill-pulverizer, and then classified by a pneumatic classifier (Elbow-jet, EJ-LABO). Thus, toner particles 5 (magenta toner particles) having a volume average particle diameter of 7 μm are produced.

(Toner Particles 6)

Toner particles 6 (magenta toner particles) are obtained in the same manner as in the case of the toner particles 3, except that the vacuum drying is continued for 4 hours.

[Preparation of External Additive]

(Silica Particles 1)

—Alkali Catalyst Solution Preparation Process (Preparation of Alkali Catalyst Solution (1))—

600 parts by mass of methanol and 90 parts by mass of 10% ammonia water are put into a 2 L-capacity reaction container made of glass that has a stirring blade, a dropping nozzle, and a thermometer, and stirred and mixed. Thus, an alkali catalyst solution (1) is obtained. At this time, the ammonia catalyst amount (NH₃ amount: NH₃ (mol)/(NH₃+methanol+water) (L)) in the alkali catalyst solution (1) is 0.62 mol/L.

—Silica Particle Forming Process (Preparation of Silica Particle Suspension (1))—

Next, the temperature of the alkali catalyst solution (1) is adjusted to 25° C., and the alkali catalyst solution (1) is subjected to nitrogen substitution. Thereafter, while stirring the alkali catalyst solution (1) at 120 rpm, dropping of 280 parts by mass of tetramethoxysilane (TMOS) and 120 parts by mass of ammonia water having a catalyst (NH₃) concentration of 4.44 mass % is started at the same time with the following supply amounts. The dropping is performed over 20 minutes, and thus a suspension of silica particles (silica particle suspension (1)) is obtained.

Here, the supply amount of tetramethoxysilane (TMOS) is adjusted to 15 g/min, that is, 0.0053 mol/(mol·min) with respect to the total mol number of methanol in the alkali catalyst solution (1). In addition, the supply amount of 4.44% ammonia water is adjusted to 6.0 g/min with respect to the total supply amount of tetraalkoxysilane that is supplied per minute. This corresponds to 0.170 mol/min with respect to 1 mol of the total supply amount of tetraalkoxysilane that is supplied per minute.

Thereafter, 250 parts by mass of the solvent of the obtained silica particle suspension (1) is distillated away by heating distillation, and 250 parts by mass of pure water is added and then dried by a freeze dryer, whereby irregular-shape hydrophilic silica particles (1) are obtained.

—Silica Particle Hydrophobization Treatment—

Furthermore, 20 parts by mass of trimethylsilane is added to 100 parts by mass of the hydrophilic silica particles (1), and reacted for 2 hours at 150° C. Thus, irregular-shape hydrophobic silica particles, of which the silica surface is subjected to a hydrophobization treatment, are obtained.

The obtained, irregular-shape hydrophobic silica particles are set to silica particles 1.

(Silica Particles 2)

Silica particles 2 are obtained in the same manner as in the case of the silica particles 1, except that 180 parts by mass of 4.44% ammonia water is supplied and the supply amount is adjusted to 9.0 g/min with respect to the total supply amount of tetraalkoxysilane that is supplied per minute.

(Silica Particles 3)

450 parts by mass of tetramethoxysilane (TMOS) and 250 parts by mass of 4.44% ammonia water are supplied, and the supply amount of tetramethoxysilane (TMOS) is adjusted to 9 g/min, that is, 0.0032 mol/(mol·min) with respect to the total mol number of methanol in the alkali catalyst solution (1). In addition, the supply amount of 4.44% ammonia water is adjusted to 5.0 g/min with respect to the total supply amount of tetraalkoxysilane that is supplied per minute. This corresponds to 0.22 mol/min with respect to 1 mol of the total supply amount of tetraalkoxysilane that is supplied per minute.

Silica particles 3 are obtained in the same manner as in the case of the silica particles 1, except for the above fact.

(Silica Particles 4)

420 parts by mass of tetramethoxysilane (TMOS) and 300 parts by mass of 4.44% ammonia water are supplied, and the supply amount of tetramethoxysilane (TMOS) is adjusted to 7 g/min, that is, 0.0025 mol/(mol·min) with respect to the total mol number of methanol in the alkali catalyst solution (1). In addition, the supply amount of 4.44% ammonia water is adjusted to 5.0 g/min with respect to the total supply amount of tetraalkoxysilane that is supplied per minute. This corresponds to 0.283 mol/min with respect to 1 mol of the total supply amount of tetraalkoxysilane that is supplied per minute.

Silica particles 4 are obtained in the same manner as in the case of the silica particles 1, except for the above fact.

(Silica Particles 5)

—Alkali Catalyst Solution Preparation Process (Preparation of Alkali Catalyst Solution (2))—

500 parts by mass of methanol and 120 parts by mass of 10% ammonia water are put into a 2 L-capacity reaction container made of glass that has a stirring blade, a dropping nozzle, and a thermometer, and stirred and mixed. Thus, an alkali catalyst solution (2) is obtained. At this time, the ammonia catalyst amount (NH₃ amount: NH₃ (mol)/(NH₃+methanol+water) (L)) in the alkali catalyst solution (2) is 0.94 mol/L.

In addition, the alkali catalyst solution (2) is used, 250 parts by mass of tetramethoxysilane (TMOS) and 250 parts by mass of 4.44% ammonia water are supplied, and the supply amount of tetramethoxysilane (TMOS) is adjusted to 5 g/min, that is, 0.0021 mol/(mol·min) with respect to the total mol number of methanol in the alkali catalyst solution (2). In addition, the supply amount of 4.44% ammonia water is adjusted to 5.0 g/min with respect to the total supply amount of tetraalkoxysilane that is supplied per minute. This corresponds to 0.397 mol/min with respect to 1 mol of the total supply amount of tetraalkoxysilane that is supplied per minute.

Silica particles 5 are obtained in the same manner as in the case of the silica particles 1, except for the above fact.

(Silica Particles 6)

600 parts by mass of tetramethoxysilane (TMOS) and 300 parts by mass of 4.44% ammonia water are supplied, and the supply amount of tetramethoxysilane (TMOS) is adjusted to 10 g/min, that is, 0.0035 mol/(mol·min) with respect to the total mol number of methanol in the alkali catalyst solution (1). In addition, the supply amount of 4.44% ammonia water is adjusted to 5.0 g/min with respect to the total supply amount of tetraalkoxysilane that is supplied per minute. This corresponds to 0.198 mol/min with respect to 1 mol of the total supply amount of tetraalkoxysilane that is supplied per minute.

Silica particles 6 are obtained in the same manner as in the case of the silica particles 1, except for the above fact.

The characteristics of the prepared silica particles are shown in Table 1.

### Examples 1 to 13 and Comparative Examples 1 to 4

In accordance with the combinations in Table 2, 0.4 part by mass of silica particles as an external additive and 0.2 part by mass of a plasticizer (RX50, produced by Nippon. Aerosil Co., Ltd.) are added to 2.0 parts by mass of the toner particles (1) and mixed for 3 minutes at 2000 rpm by a Henschel mixer, and thus toners are obtained.

The obtained respective toners and a carrier are put into a V-blender at a ratio of toner (1): carrier=5:95 (mass ratio) and stirred for 20 minutes, and thus developers are obtained.

A material prepared as follows is used as the carrier.

1,000 parts of Mn—Mg ferrite (volume average particle diameter: 50 μm, produced by Powder-tech, shape factor SF1: 120) is charged in a kneader, and a solution that is obtained by dissolving 150 parts of a perfluorooctylmethylacrylate-methylmethacrylate copolymer (polymerization ratio: 20/80, Tg: 72° C., weight average molecular weight: 72,000, produced by Soken Chemical & Engineering Co., Ltd.) in 700 parts of toluene is added thereto and mixed for 20 minutes at room temperature, and then heated at 70° C. to be subjected to reduced-pressure drying. Then, the mixture is taken out and thus a coated carrier is obtained. Furthermore, the obtained coated carrier is sieved with a 75 μm-opening mesh to remove the coarse powder, and thus a carrier is obtained. The shape factor SF1 of the carrier is 122.

[Evaluation]

The developers obtained in Examples are filled in a developing unit in a modified apparatus of Docu Centre Color 400 (manufactured by Fuji Xerox Co., Ltd), and a color stripe evaluation and a photoreceptor abrasion evaluation are performed. The results thereof are shown in Table 2.

—Color Stripe Evaluation—

The color stripe evaluation is performed as follows.

The obtained developers are filled in a developing unit in a modified apparatus of Docu Centre Color 400 (manufactured by Fuji Xerox Co., Ltd.), and under the low temperature and low humidity environment (10° C., 15% RH), 10000 images having an image density of 1% are output. Then, 100 full images having an image density of 100% are output and the number of images with stripes generated in the image portion is counted.

The evaluation reference is as follows.

A: No Generation of Color Stripes

B: 5 or less images of Color Stripes generation

C: less than 10 images of Color Stripes generation

D: 10 or greater images of Color Stripes generation

—Photoreceptor Abrasion Evaluation—

The photoreceptor abrasion evaluation is performed as follows.

In a photoreceptor after output of 100000 gradation charts under the low temperature and low humidity environment (10° C., 15% RH), a heat deflection temperature is measured at 10 points according to HDT 0.45 Mpa (ISO-75-2) by an eddy current film thickness meter, and from an average of the abrasion amounts, a photoreceptor abrasion rate is selected. Here, the photoreceptor abrasion rate means a photoreceptor abrasion amount every 1000 printouts.

It is obvious that it is advisable that the photoreceptor abrasion amount is small. However, the amount is required to be 20 nm or less, preferably 15 nm or less, more preferably 10 μm or less, and even more preferably 5 nm or less.

TABLE 1

| | Volume Average | | Standard |
|---|---|---|---|
| | Particle | Average | Deviation of |
| | Diameter(nm) | Circularity | Circularity |
| Silica Particles 1 | 140 | 0.53 | 0.15 |
| Silica Particles 2 | 140 | 0.8 | 0.08 |
| Silica Particles 3 | 340 | 0.64 | 0.27 |
| Silica Particles 4 | 340 | 0.88 | 0.19 |
| Silica Particles 5 | 120 | 0.95 | 0.03 |
| Silica Particles 6 | 450 | 0.66 | 0.28 |

TABLE 2

| | | | Toner Particle | | |
|---|---|---|---|---|---|
| | Toner | Silica | Moisture | Color Stripe | Photoreceptor |
| | Particles | Particles | Content (%) | Evaluation | Abrasion (nm) |
| Example 1 | 1 | 1 | 0.6 | A | 8 |
| Example 2 | 1 | 2 | 0.6 | A | 6 |
| Example 3 | 1 | 3 | 0.6 | B | 16 |
| Example 4 | 1 | 4 | 0.6 | B | 12 |
| Example 5 | 2 | 1 | 4.4 | B | 9 |
| Example 6 | 3 | 1 | 1.1 | A | 2 |
| Example 7 | 3 | 2 | 1.1 | A | 3 |
| Example 8 | 3 | 3 | 1.1 | B | 11 |
| Example 9 | 3 | 4 | 1.1 | B | 6 |
| Example 10 | 4 | 1 | 4.8 | B | 7 |
| Example 11 | 4 | 2 | 4.8 | B | 6 |
| Example 12 | 4 | 3 | 4.8 | C | 13 |
| Example 13 | 4 | 4 | 4.8 | C | 18 |
| Comparative | 5 | 2 | 0.05 | B | 23 |
| Example 1 | | | | | |
| Comparative | 6 | 2 | 5.2 | D | 15 |
| Example 2 | | | | | |
| Comparative | 3 | 5 | 1.1 | D | 25 |
| Example 3 | | | | | |
| Comparative | 3 | 6 | 1.1 | C | 23 |
| Example 4 | | | | | |

From the above-described results, it is found that in Examples, good results are obtained in both of the color stripe evaluation and the photoreceptor abrasion evaluation in comparison to Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
toner particles; and
an external additive,
wherein the toner particles have a moisture content of from 0.1 mass % to 5.0 mass %, and
the external additive has a volume average particle diameter of from about 70 nm to about 400 nm and an average circularity of from 0.5 to 0.9.

2. The electrostatic charge image developing toner according to claim 1,
wherein a standard deviation of the circularity of the external additive is about 0.3 or less.

3. The electrostatic charge image developing toner according to claim 1,
wherein the toner particles have a moisture content of from 0.3 mass % to 3.5 mass %.

4. The electrostatic charge image developing toner according to claim 1,
wherein the volume average particle diameter of the external additive is from about 100 nm to about 250 nm.

5. The electrostatic charge image developing toner according to claim 1,
wherein a standard deviation of the circularity of the external additive is about 0.1 or less.

6. The electrostatic charge image developing toner according to claim 1,
wherein the external additive is a plurality of silica particle.

7. The electrostatic charge image developing toner according to claim 1,
wherein the content of the external additive is 0.9 part by mass to 3.5 parts by mass with respect to 100 parts by mass of the toner particles.

8. The electrostatic charge image developing toner according to claim 1,
wherein the external additive is a plurality of silica particle that is obtained through a process of preparing an alkali catalyst solution that contains an alkali catalyst at a concentration of from about 0.6 mol/L to about 0.85 mol/L in a solvent containing an alcohol and a process of obtaining a plurality of silica particle by supplying tetraalkoxysilane to the alkali catalytic solution in a supply amount of from about 0.002 mol/(mol·min) to about 0.009 mol/(mol·min) with respect to the alcohol and by supplying an alkali catalyst in an amount of from about 0.1 mol to about 0.4 mol per 1 mol of the total supply amount of the tetraalkoxysilane that is supplied per minute.

9. An electrostatic charge image developer comprising:
the electrostatic charge image developing toner according to claim 1.

10. The electrostatic charge image developer according to claim 9,
wherein a standard deviation of the circularity of the external additive of the electrostatic charge image developing toner is about 0.3 or less.

11. The electrostatic charge image developer according to claim 9,
wherein the toner particles of the electrostatic charge image developing toner have a moisture content of from 0.3 mass % to 3.5 mass %.

12. A toner cartridge comprising:
a toner container containing the electrostatic charge image developing toner according to claim 1.

13. A process cartridge for an image forming apparatus comprising:
an image holding member; and
a developing unit that develops an electrostatic latent image formed on a surface of the image holding member by using a developer to form a toner image,
wherein the developer corresponds to the electrostatic charge image developer according to claim 9.

14. The process cartridge for an image forming apparatus according to claim 13,
wherein a standard deviation of the circularity of the external additive of the electrostatic charge image developing toner is about 0.3 or less.

15. An image forming apparatus comprising:
an image holding member;
a charging unit that charges a surface of the image holding member;
a latent image forming unit that forms an electrostatic latent image on the surface of the image holding member;
a developing unit that develops the electrostatic latent image formed on the surface of the image holding member by using a developer to form a toner image; and
a transfer unit that transfers the developed toner image onto a transfer medium,
wherein the developer is the electrostatic charge image developer according to claim 9.

16. The image forming apparatus according to claim 15,
wherein a standard deviation of the circularity of the external additive of the electrostatic charge image developing toner is about 0.3 or less.

17. The image forming apparatus according to claim 9,
wherein the toner particles of the electrostatic charge image developing toner have a moisture content of from 0.3 mass % to 3.5 mass %.

18. An image forming method comprising:
charging a surface of an image holding member;
forming an electrostatic latent image on the surface of the image holding member;
developing the electrostatic latent image formed on the surface of the image holding member by using a developer to form a toner image; and
transferring the developed toner image onto a transfer medium,
wherein the developer is the electrostatic charge image developer according to claim 9.

19. The image forming method according to claim 18,
wherein a standard deviation of the circularity of the external additive of the electrostatic charge image developing toner is about 0.3 or less.

20. The image forming method according to claim 18,
wherein the toner particles of the electrostatic charge image developing toner have a moisture content of from 0.3 mass % to 3.5 mass %.
